(19) United States
(12) Patent Application Publication
(10) Pub. No.: US 2026/0342060 A1
(43) Pub. Date: Oct. 29, 2026

(54) ONE STEP REMOVABLE WIRE MANAGER CONNECTION FOR INDOOR LUMINAIRES

(71) Applicant: SIGNIFY HOLDING B.V., EINDHOVEN (NL)

(72) Inventors: ALVARO PEQUEÑO MONDRAGON, GARCIA (MX); CARLTON BRUCE PLUNK, SALTILLO, MS (US); CHARLES CLINTON STANFORD, PONTOTOC, MS (US); JOSE ALDO RAMIREZ SALAIS, MONTEREY (MX)

(21) Appl. No.: 19/104,906

(22) PCT Filed: Aug. 28, 2023
(86) PCT No.: PCT/EP2023/073465

§ 371 Date: Feb. 19, 2025

Related U.S. Application Data
(60) Provisional application No. 63/403,398, filed on Sep. 2, 2022.

(30) Foreign Application Priority Data
Sep. 23, 2022 (EP) 22197489.2

(51) Int. Cl. H02G 3/08; H02G 1/16

(52) U.S. Cl. CPC H02G 3/085; H02G 1/16

(57) ABSTRACT

A hook device is attached to the inside of a luminaire's knockout plug such that the step of removing the knockout plug draws wires attached to the hook device out of the luminaire through the plug hole. This permits easy access to these wires for making connections with external wires. Conventional clamping devices can then be attached to secure the external wires to the luminaire and close up the plug hole.

### FIELD OF THE INVENTION

The invention relates generally to providing access to internal wires contained in a metal housing, such as the internal wires of a luminaire. In particular, the invention employs a knockout plug in the housing, the interior side of this plug having a hook mechanism serving as a wire manager for attaching internal wires of the housing. Removal of the knockout plug draws these wires out of the housing body through the knock out hole, thus enabling easy access to the wires without requiring further openings in the housing.

### BACKGROUND

Frequently, there is a need for metal housings containing internal wires to be opened to make electrical connections with outside wiring. While many such housings have removable access plates, many do not. Further, use of these access plates requires that they conform to UL certification requirements. The plate's size and its removal (and replacement) frequently do not permit easy access in making the desired connection(s). This is particular true in suspended or access limited locations of the housing. Thus in many situations, disassembly of the housing is required.

The current invention overcomes these problems in the prior art as there is no longer a requirement for an access plate. Thus, saving on construction of the housing by removing a part from its assembly, as well as avoiding the difficulties noted above in its use. Further, the wire manager function performed by the interior side of the knockout plug not only permits ready access to the internal wires, but presents these wires in an organized manner.

### SUMMARY OF THE INVENTION

While applying generally to metal housings containing electrical wiring, the invention will be discussed below with its application to indoor luminaires. The invention is not so limited, as any metal housing requiring external access to one or more of its internal wires is contemplated by the invention.

As described below, one aspect of the current invention provides a wire retention device on the interior side of a knockout plug that is positioned on the housing of a luminaire. The size of this device and the positioning of wires attached to it, enables the device to be pulled through the resulting hole as the knockout plug is removed-- thus providing easy access to the wires for making/modifying wire connections.

Another aspect of the current invention establishes a wire management system incorporated with the wire retention device.

Once the desired connections to the external wires are performed, a further aspect of the invention, permits a conventional clamping device to be employed to secure the external wires to the luminaire and to close up the plug hole in a manner complying with UL certification requirements.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the figures, elements which correspond to elements already described may have the same reference numerals. In the drawings,

FIG. 1A shows a luminaire housing 100 in accordance with one embodiment of the present invention;

FIG. 1B depicts an access knockout plug 104 in accordance with the invention;

FIG. 2 illustrates an interior view of the luminaire depicting the knockout access plug;

FIG. 3 depicts a side prospective view of the hook device 202 of the knockout access plug;

FIG. 4 illustrates the use of the hook device in the manufacturing process;

FIG. 5 illustrates the use of the hook device in an installation process; and,

FIGS. 6 and 7 illustrate the use of the knockout access plug by which removal of the plug permits access to internal wires.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

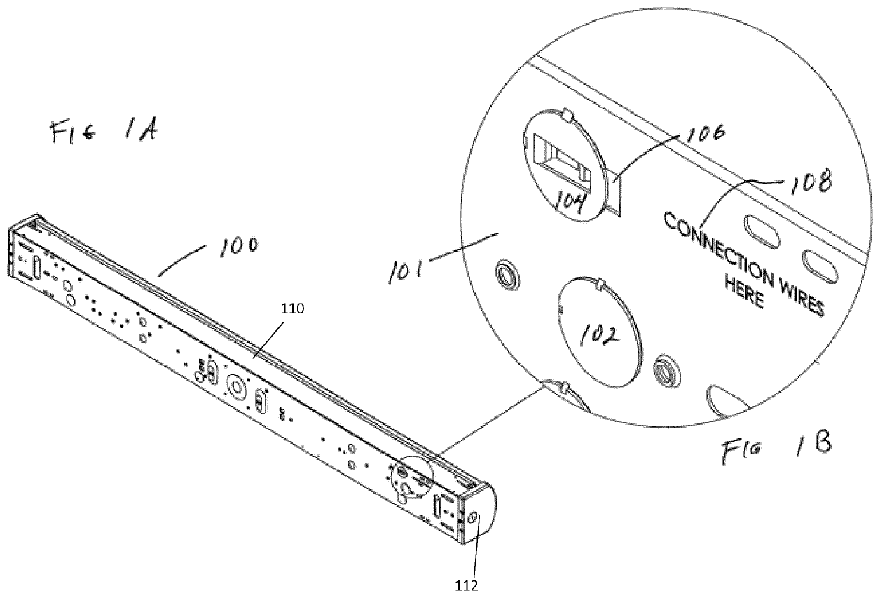

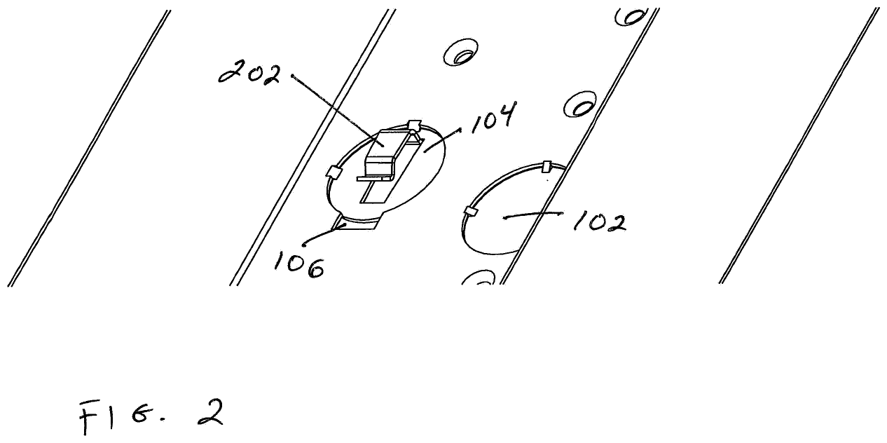

FIG. 1A shows a luminaire housing 100 in accordance with one embodiment of the present invention. The luminaire housing 100 can have two end walls/surfaces 110 and one or more side walls/surfaces 112. For example, for side walls to form a rectangle housing box. FIG. 1B shows an exploded view illustrating a conventional knockout plug 102 in the luminaire housing as well as an access knockout plug 104 in accordance with the invention. As described further below, the access knockout plug comprises a hook device 202 on its internal side that is used to attach internal wires of the luminaire. In certain embodiments of the invention, the access knockout plug is positioned in a luminaire housing orifice that comprises a square cut edge 106. This square cut edge permits introduction of a screwdriver or similar device to more readily permit removal of the access knockout plug from the exterior of the luminaire without disturbing or causing damage to the wires attached to the hook.

Also illustrated in the embodiment depicted in FIG. 1B is a label 108 identifying the location of the access knockout plug. In this embodiment the language is of a general nature: “CONNECTION WIRES HERE.” In other embodiments specific connection wires may be identified.

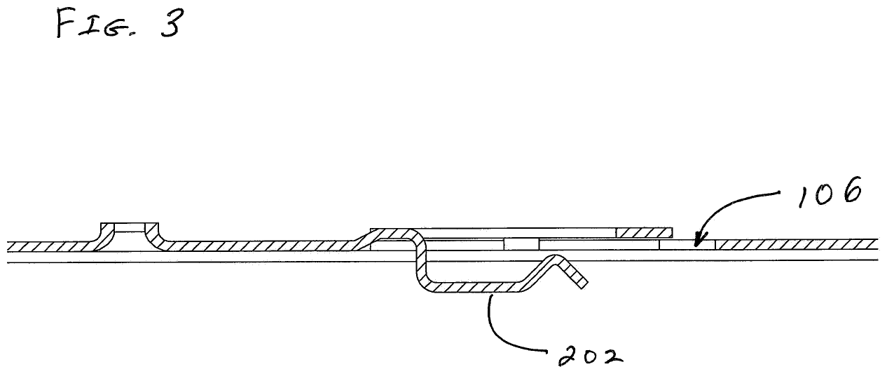

FIG. 2 is an interior view of the luminaire depicting the knockout access plug 104 and a conventional knockout plug 102 as viewed from the inside of the luminaire. As illustrated in this embodiment, the knockout access plug hook device 202 consists of a cantilevered device formed integral with the knockout access plug 104.

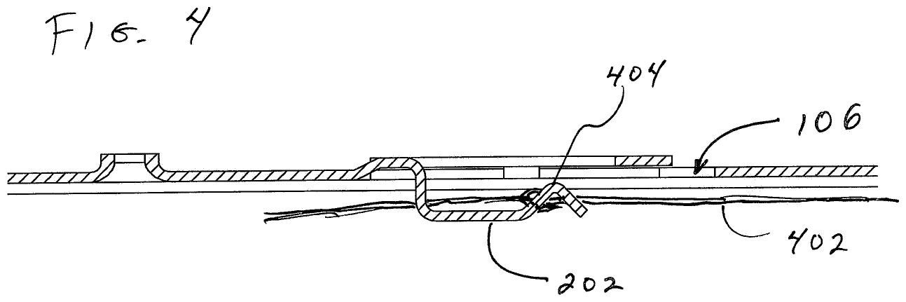

FIG. 3 depicts a side prospective view of the hook device 202. In a preferred embodiment of the invention, the hook device 202 is formed by lancing a metallic side of the luminaire housing 101, and then bending the cut material to from the hook device 202 of FIG. 2. In this manner, the knockout access plug and its hook device 202 are formed from the metal sheet material of the luminaire housing. Thus, no additional material is needed in the manufacturing of a luminaire comprising the knockout access plug of the claimed invention.

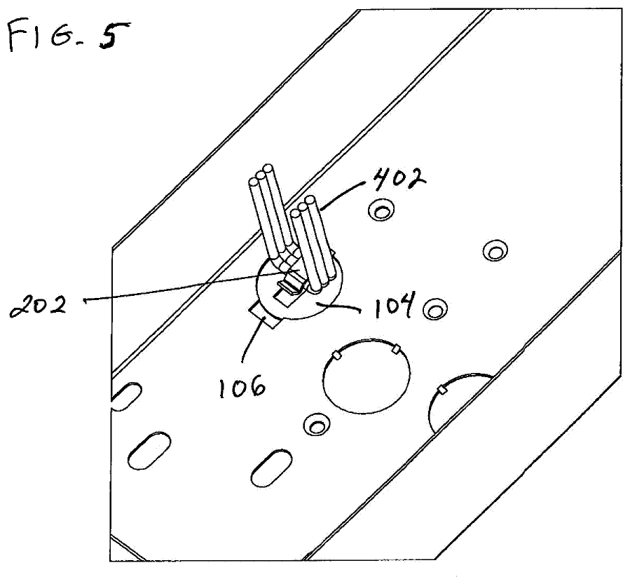

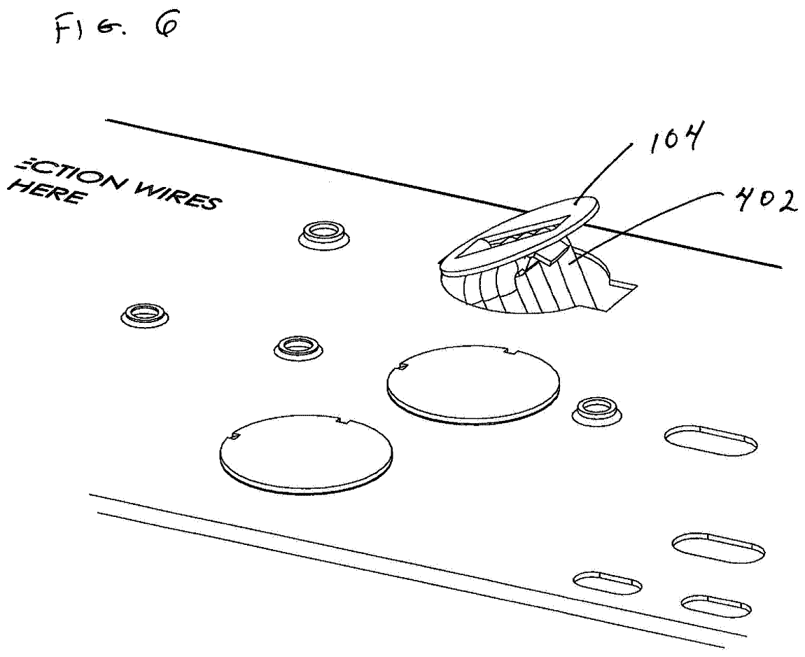

FIG. 4 depicts the use of the hook device in the manufacturing process. In the illustrated embodiment, one or more internal wires 402 are pushed into the hook through the snap-like feature 404 near the end of the hook. For thinner, more flexible wires, a loop may then be formed with the wire(s) around the hook as illustrated, to thereby secure them and prevent them from falling out of the hook. For larger internal wires 402, formation of such a loop may not be necessary, as the shape and resiliency of the access plug hook is sufficient to secure the wires (as illustrated in FIG. 5).

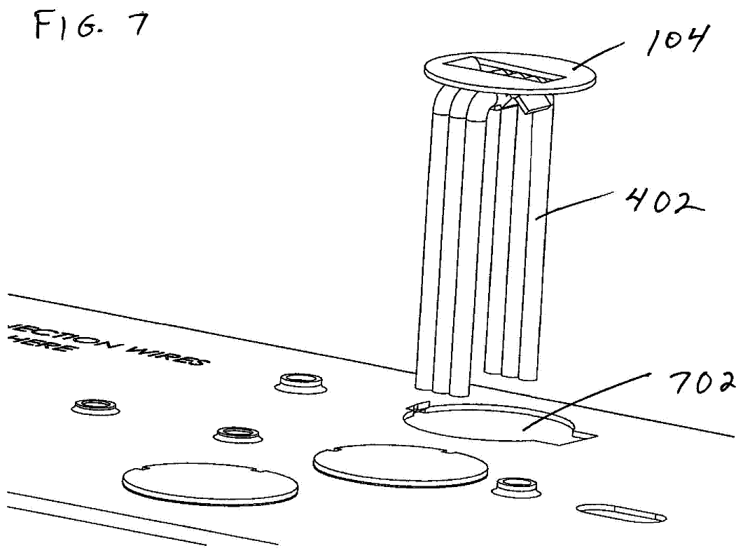

FIGS. 6 and 7 illustrate the use of the invention in an installation process. A screwdriver or similar device (not shown) is inserted in the square cut edge of knockout access plug orifice 106 to initiate removal of the plug. As the knockout access plug is removed it pulls the wires attached to its hook out of the luminaire giving easy access to internal wires. Upon completion of modification(s) to those wires and/or connection(s) with external wires, the wires can then be secured to the luminaire housing with any well-known connection device which will enclose the knockout access plug hole 702 in a manner that complies with UL certification requirements.

The foregoing detailed description has set forth a few of the many forms that the invention can take. The above examples are merely illustrative of several possible embodiments of various aspects of the present invention, wherein equivalent alterations and/or modifications will occur to others skilled in the art upon reading and understanding of the present invention and the annexed drawings. In particular, regard to the various functions performed by the above described components (devices, systems, and the like), the terms (including a reference to a “means”) used to describe such components are intended to correspond, unless otherwise indicated to any component, such as hardware or combinations thereof, which performs the specified function of the described component (i.e., that is functionally equivalent), even though not structurally equivalent to the disclosed structure which performs the function in the illustrated implementations of the disclosure.

Although a particular feature of the present invention may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A housing having an interior space enclosing at least one electrical wire, wherein housing have one or more wall surfaces, said one or more wall surfaces having at least one metal surface, the metal surface comprising:
a metallic knockout access plug having an interior side facing the interior space of the housing, the interior side comprising a hook,
wherein in manufacturing of the housing, the at least one electrical wire is attached to the hook,
wherein in installation or maintenance of the housing, removal of the access plug draws the at least one wire out of the housing thereby permitting access to the at least one wire to permit making electrical connections with one or more external wires.

2. The housing of claim 1, wherein the hook is formed by cutting and bending the knockout access plug.

3. The housing of claim 2, wherein the hook is biased in a direction opposite to that of the interior space of the housing.

4. The housing of claim 1, wherein the metal surface further comprises a square cut edge adjacent the knockout access plug to enable removal of the knockout access plug.

5. The housing of claim 3, wherein the housing is a luminaire.

6. The housing of claim 5, wherein the hook serves a wire manager for a plurality of wires internal to the luminaire.

7. The housing of claim 5, wherein removal of the knockout access plug creates a hole in the housing that is sized to be enclosed by a conventional cable connection device.

8. A method of providing access to at least one wire contained in the interior space of a housing, the housing having at least one metal surface, the method comprising:
forming a metallic knockout access plug on said at least one metal surface, the knockout access plug having a hook device on a surface facing the interior space of the housing,
attaching the at least one electrical wire to the hook,
removing the knockout access plug draws the at least one wire out of the housing thereby permitting access to the at least one wire.

9. The method of claim 8, wherein the forming step comprises cutting and bending the knockout access plug.

10. The method of claim 9, wherein the forming step comprises bending the hook so that it is biased in a direction opposite to that of the interior space of the housing.

11. The method of claim 9 further comprising a step of providing a square cut edge adjacent the knockout access plug to enable removal of the knockout access plug.

12. The method of claim 9, wherein the housing is a luminaire.

13. The method of claim 12, wherein the hook serves a wire manager for a plurality of wires internal to the luminaire.

14. The method of claim 12, wherein permitting access to the at least one wire enables performing a connection with said at least one wire with a wire external to the housing.

15. The method of claim 14 wherein the removing step creates a hole in the housing, and the method further comprises a step of enclosing said hole with a conventional cable connection device which secures the external wire to the luminaire.
